(19) United States
(12) Patent Application Publication
(10) Pub. No.: US 2024/0137701 A1
(43) Pub. Date: Apr. 25, 2024

(54) A WIRELESS EARPHONE/HEADPHONE SYSTEM

(71) Applicant: Danny MANU, Cambridge Cambridgeshire (GB)

(72) Inventor: Danny MANU, Cambridge Cambridgeshire (GB)

(21) Appl. No.: 18/546,538

(22) PCT Filed: Feb. 17, 2021
(86) PCT No.: PCT/IB2021/051338

§ 371 Date: Aug. 14, 2023

(51) Int. Cl. H04R 5/033

(52) U.S. Cl. CPC H04R 5/033; H04R 2201/107; H04R 2420/07

(57) ABSTRACT

In A wireless earphone/headphone system A wireless earphone/headphone system comprises a band (3) configured to be h worn by a user so as to extend at least between the ears of the user; a pair of speaker units (2) connected to the headband (3) and configured to be worn on or in the ears of a user with at least part of the unit (2) located within or on the ear of the user; a control unit (4) connected to the speaker units (2) and configured for wireless connection to a mobile network so as to enable one or more of: voice calling; texting; audio streaming.

### FIELD

The present invention relates to a wireless earphone/headphone system. More particularly, the present invention relates to a standalone or cellular connection wireless earphone/headphone system. Even more particularly, the present invention relates to a wireless earphone/headphone system that enables the user to make and receive calls and texts and stream music without the need for an associated mobile device to be present or switched on.

### BACKGROUND

Generally, earphones and headphones can be connected to an audio source via a cable or wireless connection.

It is mostly but not exclusively common for over-ear headphones to have a built-in or hardwired cable, one end connected to the headphones, and the other free end having a jack plug that can be pushed into a corresponding socket to connect to an audio source.

Recently, less bulky in-ear wireless headphones and earphones have become increasingly common, especially for sports or similar activities. Headphones and earphones of this type usually comprise a pair of in-ear speaker units, sometimes connected by short lengths of cable that run from the speaker units to a wireless receiver. In other designs there is no cable between the two speaker units and in this case the wireless receivers/s are usually located within the earpieces themselves. In use a wearer positions the speaker units in their ears, with, for example, the cable running across the back of their neck, and with the wireless receiver clipped to their collar or lapel, or hanging down freely. The wireless receiver receives a signal transmitted from a remote unit, such as for example a bluetooth signal from a smartphone or similar device, which may be located in the pocket of a user, in a pouch or pocket on their arm, or a remote yet proximate location. The casing or housing for the wireless receiver usually also contains a battery, that is used to power the wireless receiver and the headphone units.

It is known for over-ear headphones to include dual functionality, where they can be directly connected via a cable and jack/socket connection to an audio source, or they can receive an audio signal wirelessly from the source. For example, V-Moda's Crossfade over-ear headphones and Philips SHB7000/28 Bluetooth Stereo Headsets have both wired functionality, and wireless functionality via Bluetooth.

However, most in-ear wireless headphones do not include a hardwire connection option, in order to keep the profile and mass as low as possible.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a wireless earphone/headphone system which goes some way to overcoming the abovementioned disadvantages or which at least provides the public or industry with a useful choice.

It is a further object of the present invention to provide a wireless earphone/headphone system which has a standalone or cellular connection system which goes some way to overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist of a wireless earphone/headphone system, comprising: a band configured to be worn by a user so as to extend at least between the ears of the user; a pair of speaker units connected to the headband and configured to be worn on or in the ears of a user with at least part of the unit located within or on the ear of the user; a control unit connected to the speaker units and configured for wireless connection to a mobile network so as to enable one or more of: voice calling; texting; audio streaming.

In an embodiment, the control units are located within the band.

In an embodiment, the wireless earphone/headphone system further comprises a microphone configured to receive spoken audio input from a user, and wherein the control unit comprises: a control module; a wireless transmitter/receiver configured for communication with a remote device or devices; a data processing unit configured to receive and respond to voice commands from a user, and; a memory or data storage module configured for storage of data relating to user contacts, and audio files.

In an embodiment, the wireless transmitter/receiver is configured for connection to an external cellular network.

In an embodiment, the wireless transmitter/receiver comprises an LTE module with eSIM capability, and is adapted for connection to an external network.

In an embodiment, the band comprises a headband formed from a resiliently flexible material that connects to the speaker units towards each end, the body of the band extending and curving over the head of a user.

In an embodiment, the band comprises a neckband formed from a resiliently flexible material that connects to the speaker units towards each end, the body of the band extending and curving behind the neck of a user.

In an embodiment, the band comprises an over-the-head band configured to be worn on the head of a user.

With respect to the above description then, it is to be realised that the optimum dimensional relationships for the parts of the invention, to include variations in size, materials, shape, form, function and manner of operation, assembly and use, are deemed readily apparent and obvious to one skilled in the art and all equivalent relationships to those illustrated in the drawings and described in the specification and any other similar designs are intended to be encompassed by the present invention.

This invention may also be said broadly to consist of the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents and variations may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a first embodiment of the wireless earphone/headphone system of the present invention, comprising a pair of in-ear speaker units configured to be worn with at least part of the unit located within the ear of the user, a connecting band structure running between and connecting the speaker units, the band structure containing an ESIM and LTE module and a data processing unit.

### DETAILED DESCRIPTION

Embodiments of the invention, and variations thereof, will now be described in detail with reference to the figures.

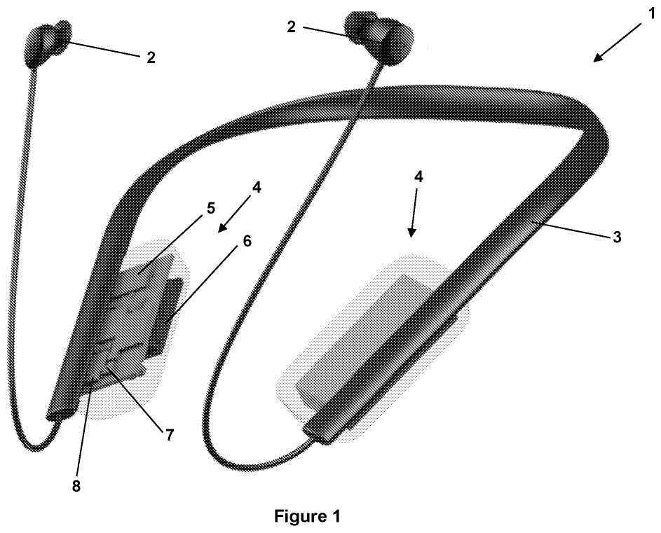

An embodiment of wireless earphone/headphone system 1 is shown in FIG. 1. The system 1 in this embodiment has four main parts: a pair of in-ear or on ear speaker units 2, a band 3, and control units 4.

The in-ear/on-ear speaker units 2 are configured to be worn in/on the ears of a user with at least part of the unit located within the ear of the user, so that they remain in position and the user can hear the audio from the speakers.

The band 3 in this embodiment comprises a headband formed from a resiliently flexible material that connects to the in-ear/on-ear speaker units 2 towards each end, with the main part of the band 3 extending and curving over the head of a user, generally following the outside of their head. A microphone (not shown) is located within the headband, and is configured to receive voice input from a user wearing the headband.

In variations, the band could be a neckband containing supporting circuitry and rechargeable battery, or another suitable variation such as over-the-head headphones configured to be worn either or together in the ears, an around-the-neck band, or a band configured to be worn on the head.

The control units 4 in this embodiment are located within the band 3, which forms a housing that holds the control units 4, plus a battery (not shown), and a wireless transmitter/receiver 5 that in the preferred embodiment comprises an LTE module with eSIM capability so that connection can be established with an external cellular network.

The control units 4 comprise: a control module 6; a data processing unit 7 that is configured to receive and respond to voice commands from a user via the microphone to establish a call or send a text message, and; a memory or data storage module 8.

The control module 6 is configured to act as a central controller for the headphone system 1. That is, to receive and transmit data to the other control units, and to transmit commands to these as required.

In use, if a user wearing the earphone/headphone system 1 wishes to play music or audio, then they do so directly from the memory or data storage module 8, without the need for an external connection.

A user can also play audio from their mobile device, with the earphone/headphone system 1 connecting to a remote mobile device via the wireless transmitter/receiver 5 so that audio can be ‘streamed’ to the in-ear/on-ear speaker units 2 via the control module 6 and wireless transmitter/receiver 5.

A user can also receive and place telephone calls, either using a connection to a remote mobile device via the wireless transmitter/receiver 5, or by using built-in hardware and functionality in the earphone/headphone system 1. In the preferred embodiment, the voice service is supported via 4G access network (Voice over LTE and LTE-M access technology). That is, the control units 4 support and utilise the 4G access network.

A user can sync their contacts, or their music stream, or both, from their mobile device into the earphone/headphone system 1, so that they can make voice calls without the use of a companion device (i.e. a mobile phone or other type of mobile device). To make calls, a user uses voice commands that are received by the microphone and on-transmitted to the control units 4. Incoming calls are announced to a user via the in-ear/on-ear speaker units 2. A user can use voice commands to answer or reject a call.

The earphone or headphone system 1 also supports an SMS messaging service (both receiving and sending) with and without the use of a connected companion device (e.g. a smartphone). Other messaging services (e.g. WhatsApp, Viber, FB Messaging etc.) are also supported. A user can sync their contacts from their mobile device onto the earphone or headphone system 1. This enables them to send a message without the use of the companion device, by using the hardware and software of the earphone or headphone system 1.

In the preferred embodiment, the user uses audio commands to command the control units 4 to send text messages. Incoming text messages are announced in the user's ears via the speaker units 2 and are ‘read out’ to a wearer, on command.

Music services are supported via uploading songs on the earbud or streaming directly through the users service provider via earbuds LTE cellular connection.

1. A wireless earphone/headphone system, comprising:
a band (3) configured to be worn by a user so as to extend at least between the ears of the user;
a pair of speaker units (2) connected to the headband (3) and configured to be worn on or in the ears of a user with at least part of the unit (2) located within or on the ear of the user;
a control unit (4) connected to the speaker units (2) and configured for wireless connection to a mobile network so as to enable one or more of: voice calling; texting; audio streaming.

2. A wireless earphone/headphone system as claimed in claim 1 wherein the control units are located within the band.

3. A wireless earphone/headphone system as claimed in claim 1 or claim 2 further comprising a microphone configured to receive spoken audio input from a user, and wherein the control unit comprises: a control module; a wireless transmitter/receiver configured for communication with a remote device or devices; a data processing unit configured to receive and respond to voice commands from a user, and; a memory or data storage module configured for storage of data relating to user contacts, and audio files.

4. A wireless earphone/headphone system as claimed in claim 3 wherein the wireless transmitter/receiver is configured for connection to an external cellular network.

5. A wireless earphone/headphone system as claimed in claim 5 wherein the wireless transmitter/receiver comprises an LTE module with eSIM capability, and is adapted for connection to an external network.

6. A wireless earphone/headphone system as claimed in any one of claims 1 to 5 wherein the band comprises a headband formed from a resiliently flexible material that connects to the speaker units towards each end, the body of the band extending and curving over the head of a user.

7. A wireless earphone/headphone system as claimed in any one of claims 1 to 5 wherein the band comprises a neckband formed from a resiliently flexible material that connects to the speaker units towards each end, the body of the band extending and curving behind the neck of a user.

8. A wireless earphone/headphone system as claimed in any one of claims 1 to 5 wherein the band comprises an over-the-head band configured to be worn on the head of a user.
